(19) United States
(12) Patent Application Publication
(10) Pub. No.: US 2021/0355999 A1
(43) Pub. Date: Nov. 18, 2021

(54) Torsional vibration damper

(71) Applicant: Schaeffler Technologies AG & Co. KG, Herzogenaurach (DE)

(72) Inventors: Thomas Janz, Bühl (DE); Pascal Strasser, Aschbach (FR); Sascha Büchner, Karlsruhe (DE)

(73) Assignee: Schaeffler Technologies AG & Co. KG, Herzogenaurach (DE)

(21) Appl. No.: 17/284,662

(22) PCT Filed: Oct. 16, 2019
(86) PCT No.: PCT/DE2019/100897

§ 371 Date: Apr. 12, 2021

(30) Foreign Application Priority Data
Oct. 16, 2018 (DE) 10 2018 125 570.5

(51) Int. Cl. F16D 7/02; F16D 3/12; F16D 3/14; F16F 15/129; F16F 15/123

(52) U.S. Cl. CPC F16D 7/025; F16D 3/12; F16D 3/14; F16F 15/1297; F16D 2300/22; F16F 2222/04; F16F 2232/02; F16F 2236/08; F16D 2300/06; F16F 15/12353

(57) ABSTRACT

A torsional vibration damper comprising an input part arranged about an axis of rotation and an output part arranged such that it can rotate relative to same, about the axis of rotation and against the effect of a spring unit is provided. The spring unit is impacted in the peripheral direction respectively on the input side and the output side, and a torque-limiting unit, including a flange part impacting the spring unit on the output side and lateral parts arranged on both sides of the flange part and forming a frictional connection with same by means of an axial clamping, is arranged between the spring unit and a driven part of the output part. The flange part is clamped between a first and a second lateral part by a disc spring axially supported on a counter bearing of the first lateral part and axially pretensioning the second lateral par against the flange part.

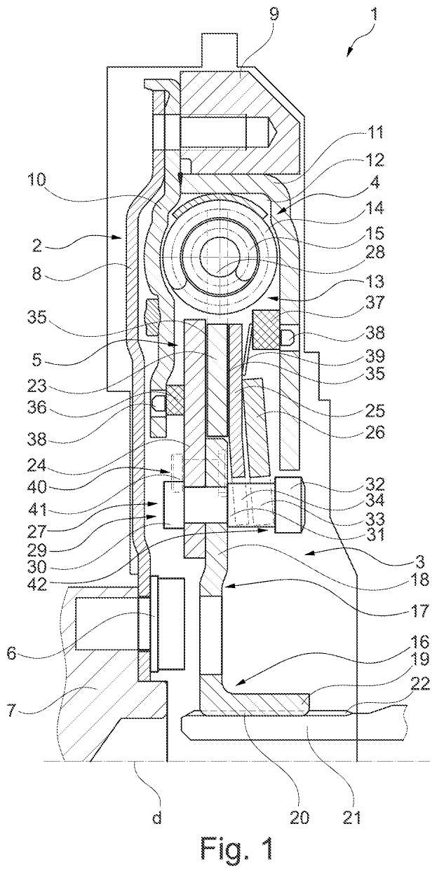

### CROSS-REFERENCE TO RELATED APPLICATIONS

This application is the U.S. National Phase of PCT Appln. No. PCT/DE2019/100897 filed Oct. 16, 2019, which claims priority to DE 10201812570.5 filed Oct. 16, 2018, the entire disclosures of which are incorporated by reference herein.

### TECHNICAL FIELD

The disclosure relates to a torsional vibration damper having an input part arranged about an axis of rotation and an output part arranged so as to be rotatable relative to the axis of rotation against the action of a spring unit, wherein the spring unit is impacted on each of the input side and output side in the peripheral direction and, between the spring unit and a driven part of the output part, a torque-limiting device containing a flange part impacting the spring unit on the output side and lateral parts arranged on both sides thereof and producing a frictional connection therewith by means of an axial clamping.

### BACKGROUND

A generic torsional vibration damper is known, for example, from DE 10 2014 218 966 A1. With this torsional vibration damper, a torque-limiting device is provided between a spring unit and a driven hub, which is formed from a flange part impacting on the spring unit on the output side and two lateral parts clamping the flange part, forming a frictional engagement defining the transferable torque. The flange part is designed radially on the inside as a plate spring, the force edge of which is axially pretensioned radially on the outside with respect to a first lateral part and radially on the inside with respect to the second lateral part. Friction linings lying radially one above the other are arranged on the friction surfaces between the lateral parts and the flange part.

The object of the disclosure is to further develop a generic torsional vibration damper. In particular, the object is to set the maximum torque that can be transmitted via the torque-limiting device in a reproducible manner.

The object is achieved by the subject matter of the claims. The claims provide advantageous embodiments of the subject matter.

The proposed torsional vibration damper is used for torsional vibration isolation in particular for a drive train of a motor vehicle having an internal combustion engine subject to torsional vibrations. For this purpose, the torsional vibration damper contains an input part which is arranged to be rotatable about an axis of rotation and an output part which is arranged to be rotatable about the axis of rotation against the action of a spring unit relative thereto. The torsional vibration damper can be designed as a dual-mass flywheel, wherein the input part contains a primary flywheel mass and the output part contains a secondary flywheel mass. The secondary flywheel mass can be provided at least partially in a downstream drive train device, for example a double clutch, a hydrodynamic torque converter or the like, to which the output part is connected in a rotationally locked manner. The input part can be received on a crankshaft by means of fastening openings, if necessary with the interposition of a reinforcing ring.

The input part can, for example by means of two disk parts, form an annular chamber radially on the outside, in which the spring unit is received. The spring unit is formed, for example, from a plurality of bow springs or bow spring sets with bow springs nested one inside the other, which are arranged distributed over the circumference.

The spring unit is effectively arranged in the peripheral direction between the input part and the output part. The input part and the output part are mounted on one another by means of a bearing, for example a sliding or roller bearing. Alternatively, the input part is centered on the crankshaft and the output part is centered on a shaft such as the transmission input shaft of a gearbox or a stub shaft of a drive train device connected upstream of the gearbox, wherein a corresponding axial offset is provided within the torsional vibration damper, for example on impacting devices of the spring units.

The input part and the output part have said impacting devices which engage between the adjacent end faces of the bow springs. The input part has embossings formed, for example, in the disk parts of the annular chamber. The output part has a flange part, the radially widened arms of which engage between the end faces of the bow springs which are adjacent in the peripheral direction.

A torque-limiting device is provided between the spring unit and the driven part of the output part. A driven part is to be understood to mean, for example, a driven hub that is connected in a rotationally locked manner to an externally toothed shaft or a stub shaft by means of internal toothing. Alternatively, the driven part can be designed as a flywheel mass disk that receives a clutch pressure plate to form a friction clutch.

The torque-limiting device contains the flange part which impacts on the spring unit on the output side and lateral parts which are arranged on both sides thereof and which produce a frictional connection by means of an axial clamping. The torque-limiting device is preferably arranged radially inside the spring unit.

For further torsional vibration isolation supporting the torsional vibration damping of the spring unit, for example in conjunction with a primary flywheel mass of the input part and a secondary flywheel mass of the output part, at least one centrifugal pendulum can be integrated into the torsional vibration damper, which can be provided, for example, axially next to the spring unit, radially inside the spring unit, axially next to the torque-limiting device, or at another point.

In the proposed torsional vibration damper, the torque-limiting device for setting a precisely adjustable maximum torque that can be transmitted via the torque-limiting device is designed in such a way that the flange part is clamped between a first and a second lateral part by means of a plate spring axially supported on a counter bearing of the first lateral part and axially pretensioning the second lateral part against the flange part. This means that one lateral part is axially pretensioned with respect to the other lateral part and the flange part itself is designed to be flat without a force edge. As a result, the friction surfaces are formed between the lateral parts on the one hand and the flange part axially opposite one another and with an almost entire surface over the overlap of the flange part and lateral parts, so that the friction surface is increased and can be made reproducible by means of the pretension applied externally on a lateral part by means of an external plate spring. Due to the enlarged friction surface, the maximum torque that can be transmitted can also be increased or, with a lower pretension, a lower torque can be transmitted with improved accuracy.

The counter bearing serves to axially support the plate spring and has stop surfaces axially spaced apart from the first lateral part so that the flange part, the second lateral part and the plate spring with their axial spring travel can be accommodated between the first lateral part. It has proven to be advantageous if the counter bearing enables a rotational connection of the plate spring and the second lateral part with the first lateral part, so that a relative rotation of the flange part with respect to the lateral parts is provided exclusively on the friction surfaces of the friction linings. Furthermore, it has proven to be advantageous if the second lateral part and the plate spring are centered on the counter bearing.

For example, the first lateral part and a driven part of the output part, in particular a driven hub, can be integrally connected to one another. Here, tabs distributed over the circumference can be exposed from the first lateral part, which form the counter bearing. Alternatively, spacer bolts can be distributed over the circumference on a corresponding pitch circle on the first lateral part.

According to a preferred embodiment of the torsional vibration damper, the driven part of the output part is connected to the first lateral part by means of riveting and the counter bearing is formed by means of rivets of the riveting arranged distributed over the circumference. The driven part can be designed as a driven hub, wherein a hub flange of the driven hub is connected to the first lateral part by means of riveting. The rivets can be designed as step bolts, which connect the first lateral part to the hub flange and have setting heads forming the counter bearing at an axial distance from one another. To increase the rigidity of the torque-limiting device, in addition to this first riveting forming the counter bearing, a second riveting can be provided with rivets distributed radially over the circumference outside the pitch circle of the first riveting on a larger pitch circle.

In a further embodiment, the driven part can be designed as a secondary disk flywheel forming a secondary flywheel mass, which is connected to the first lateral part, for example, by means of spacer bolts forming the riveting. The second lateral part and the disk spring are accommodated at an axial distance between the secondary disk flywheel and the first lateral part, the plate spring and the lateral part being axially supported on the secondary disk flywheel and centered on the spacer bolts in a rotationally locked manner.

The hub flange of the driven hub can be arranged axially between the lateral parts and center the flange part on its outer circumference.

The friction linings can be greased for improved setting of the maximum torque that can be transmitted via the torque-limiting device. In addition, the spring unit accommodated in the annular chamber can be greased. Sufficient greasing of the spring unit and the torque-limiting device arranged directly radially within the spring unit means that the friction linings of the torque-limiting device can be greased over the service life.

### BRIEF DESCRIPTION OF THE DRAWINGS

The disclosure is explained in more detail with reference to the exemplary embodiment in the single FIGURE. This shows the upper part of a torsional vibration damper arranged to be rotatable about an axis of rotation, in section.

### DETAILED DESCRIPTION

The FIGURE shows the upper part of the torsional vibration damper 1 arranged about the axis of rotation d in section with the input part 2, and the output part 3 with the torque-limiting device 5, which can be rotated relative to the axis of rotation d against the action of the spring unit 4.

The input part 2 is received on the crankshaft 7 by means of the screws 6. The drive plate 8 with the fastening openings for the screws 6 is designed to be axially flexible to dampen axial, shielding and/or wobble vibrations of the crankshaft 7 and is connected to the mass ring 9 and the disk part 10 radially on the outside by means of screws (not shown).

The disk part 10 and the disk part 11 are tightly connected to one another, as welded here. The disk part 11 receives the mass ring 9 at its radially outer axial extension. The disk parts 10, 11 form the annular chamber 12 in which the spring unit 4 is housed. The spring unit 4 is formed from bow spring sets 13 with bow springs 14, 15 nested one inside the other, which are arranged distributed over the circumference. The end faces of the bow springs 14, 15, which are adjacent in the peripheral direction, are each impacted on the input side by impacting devices (not shown), for example embossings provided in the disk parts 10, 11.

The output part 3 contains the torque-limiting device 5 arranged radially inside the spring unit 4 and the driven part 16, which is designed as a driven hub 17 with the hub flange 18 and the hub 19 with the internal toothing 20. The hub 19 is rotatably connected to the external toothing 22 of the shaft 21 or a stub shaft. In the ideal case, the axis of rotation d corresponds to the axis of rotation of the shaft 21. In the event of an axial offset, compensation occurs internally between the input part 2 and the output part 3, for example on the spring unit 4.

The torque-limiting device 5 contains the flange part 23, the two lateral parts 24, 25, the plate spring 26 and the rivets 27 distributed over the circumference. The flange part 23 serves to act on the bow springs 14, 15 on the output side and has radially widened arms 28 for this purpose, which engage between the peripherally adjacent end faces of the bow springs 14, 15 and impact on them in both peripheral directions.

The first lateral part 24 is connected to the hub flange 18 of the driven hub 17 by means of the rivets 27 of the riveting 29. The rivets 27 are designed as spacer bolts 30 which have the axial widening area 31 and the setting head 32 adjoining the same. The second lateral part 25 and the plate spring 26 are received and centered in a rotationally locked manner on the expansion areas 31 by means of internal profiles 33, 34. The plate spring 26 is axially supported on the setting heads 32 and is axially pretensioned against the second lateral part 25, which forms with the first lateral part 24 a frictional clamping connection with the flange part 23. The setting heads 32 of the rivets 27 form the counter bearing 42, which is connected to the first lateral part 24, for the plate spring 26.

Friction linings 35 are arranged on both sides of the flange part 23, which are arranged axially opposite one another and substantially occupy the clamping surface between the lateral parts 24, 25 and the flange part 23. In an alternative embodiment, the friction linings 35 can be attached to the lateral parts 24, 25. The friction linings 35 can be glued to the corresponding components and made, for example, as paper linings, from material mixtures with friction material or as friction plates. Because of the flat friction surfaces between the friction linings and counter-friction surfaces made of steel, a reproducible and possibly high friction torque can be set depending on the pretension of the plate spring 26. Due to a sustainable and low-friction operation of the annular chamber 12, which is arranged radially directly outside the flange part 23 and filled with lubricant for greasing the spring unit 4, a constant setting of the maximum torque which can be transmitted via the torque-limiting device 5 is achieved over the service life.

To set a basic friction between the input part 2 and output part 3, a seal of the annular chamber 12, for the axial positioning of the output part 3 relative to the input part 2, the two friction rings 36, 37 are provided, which are held in the disk parts 10, 11 in a rotationally fixed manner by means of pins 38. The axial pretensioning and positioning of the output part 3 with respect to the input part 2 is performed by the plate spring 39, which is supported on the second lateral part 25 and centered on the plate spring 26. The plate spring 39 is pretensioned against the friction ring 37, so that the first lateral part 24 abuts the friction ring 36. The axial pretensioning of the plate spring 39 is substantially negligible compared to the plate spring 26 for developing the effect of the torque-limiting device 5.

In order to make the torque-limiting device 5 more rigid, in addition to the riveting 29, the riveting 40 can be provided between the first lateral part 24 and the hub flange 18 with a larger diameter by means of the rivets 41 arranged over the circumference.

### LIST OF REFERENCE NUMBERS

1 Torsional vibration damper
2 Input part
3 Output part
4 Spring unit
5 Torque-limiting device
6 Screw
7 Crankshaft
8 Drive plate
9 Mass ring
10 Disk part
11 Disk part
12 Annular chamber
13 Bow spring set
14 Bow spring
15 Bow spring
16 Driven part
17 Driven hub
18 Hub flange
19 Hub
20 Internal toothing
21 Shaft
22 External toothing
23 Flange part
24 Lateral part
25 Lateral part
26 Plate spring
27 Rivet
28 Arm
29 Riveting
30 Spacer bolt
31 Expansion area
32 Setting head
33 Internal profile
34 Internal profile
35 Friction lining
36 Friction ring
37 Friction ring
38 Pin
39 Plate spring
40 Riveting
41 Rivet
42 Counter bearing
d Axis of rotation

1. A torsional vibration damper comprising:
an input part arranged about an axis of rotation;
an output part arranged so as to be rotatable relative to the axis of rotation against an action of a spring unit, wherein the spring unit is impacted on each of an input side and output side in a peripheral direction; and
a torque-limiting device disposed between the spring unit and a driven part of the output part and including a flange part impacting the spring unit on the output side and lateral parts arranged on both sides of the flange part and producing a frictional connection therewith by an axial clamping, wherein the flange part is clamped between a first and a second lateral part by a plate spring axially supported on a counter bearing of the first lateral part and axially pretensioning the second lateral part against the flange part.

2. The torsional vibration damper according to claim 1, wherein the second lateral part and the plate spring are rotatably received and centered on the counter bearing.

3. The torsional vibration damper according to claim 1, wherein the first lateral part and the driven part are integrally connected to one another.

4. The torsional vibration damper according to claim 3, the counter bearing is formed from rivets connected to the first lateral part.

5. The torsional vibration damper according to claim 1, wherein the driven part is connected to the first lateral part by a riveting connection and the counter bearing is formed by rivets of the riveting connection distributed over a circumference.

6. The torsional vibration damper according to claim 5, wherein the driven part is designed as a driven hub and a hub flange is connected to the first lateral part by the riveting connection.

7. The torsional vibration damper according to claim 6, wherein the rivets are designed as spacer bolts which connect the first lateral part to the hub flange and have axially spaced setting heads forming the counter bearing.

8. The torsional vibration damper according to claim 6, wherein the flange part is centered on the hub flange.

9. The torsional vibration damper according to claim 1, wherein axially opposite friction linings attached to the flange part or to the lateral parts are provided between the flange part and the lateral parts.

10. The torsional vibration damper according to claim 9, wherein the friction linings are greased.

11. A torsional vibration damper comprising:
an input part rotatable about an axis of rotation;
an output part rotatable about the axis of rotation against an action of a spring unit, wherein the output part includes a driven hub and hub flange; and
a torque-limiting device disposed between the spring unit and the driven hub, wherein the torque-limiting device includes:
a flange part engaged with the spring unit on an output side;
a first lateral part and a second lateral part arranged on axially opposite sides of the flange part; and
a plate spring axially supported on a counter bearing and configured to clamp the flange part between the first and the second lateral parts, wherein the hub flange of the output part is connected to the first lateral part by a riveted connection and the counter bearing is formed by rivets of the riveted connection distributed over a circumference thereof.

12. The torsional vibration damper according to claim 11, wherein the rivets include an axial section and the second lateral part and the plate spring are received and centered in a rotationally locked manner on the axial section.
